(19) United States
(12) Patent Application Publication
(10) Pub. No.: US 2025/0144457 A1
(43) Pub. Date: May 8, 2025

(54) Fire Protection for a Parking Garage

(71) Applicant: Robotic Technology Administration, LLC, Clearwater, FL (US)

(72) Inventor: Royce S. Monteverdi, Clearwater, FL (US)

(21) Appl. No.: 18/926,937

(22) Filed: Oct. 25, 2024

Related U.S. Application Data
(60) Provisional application No. 63/596,301, filed on Nov. 5, 2023.

(51) Int. Cl. A62C 3/00; E04H 6/22

(52) U.S. Cl. CPC A62C 3/002; E04H 6/22

(57) ABSTRACT

Disclosed in example embodiments herein are a system, method, and computer readable medium of instructions for providing fire protection in a parking garage. A level or floor of the parking garage has a designated storage space for containing fires. Sensors in storage spaces (e.g., parking areas) detect whether there is a risk fire in a storage space based on sensor data, such as a heat signature. When a risk of a fire is detected, the contents of the storage space where the risk of a fire was detected are automatically moved to the designated storage space for containing fires.

### CROSS REFERENCE TO RELATED APPLICATIONS

This application claims the benefit under 35 U.S.C. § 119 of U.S. Provisional Application No. 63/596,301 filed Nov. 5, 2023. The contents of the aforementioned application are hereby incorporated by reference herein in its entirety.

### TECHNICAL FIELD

The present disclosure relates generally to parking garages, including but not limited to robotic parking garages.

### BACKGROUND

Vehicles stored in a parking garage can pose a fire hazard within the garage. Internal Combustion Engine (“ICE”) vehicles employ flammable liquids and solids such as gasoline and plastic parts. Electric Vehicles (EVs) are prone to thermal runaway of their batteries and EV fires tend to burn hotter and longer than fires from ICE vehicles.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein is a fire protection system for a parking garage. The garage storage areas are monitored by sensors. The garage further comprises a designated storage space for containing fires, and a carrier for automatically moving the contents of storage space where a condition indicative of a fire was detected to the designated storage space for containing fires.

In accordance with an example embodiment, there is disclosed herein a method for providing fire protection to a parking garage. The method comprises detecting a heat signature indicative of a fire in a storage space within the parking garage. In response to detecting the condition indicative of a fire, automatically moving the contents of the storage space where the risk of a fire was detected to a designated storage space for containing fires.

In accordance with an example embodiment, there is disclosed herein a computer readable medium of instructions. Upon execution, the instructions cause a processor to implement a method for providing fire protection for a parking garage as described herein.

### BRIEF DESCRIPTION OF THE DRAWINGS

The accompanying drawings incorporated herein and forming a part of the specification illustrate the example embodiments.

FIG. 1 is a cutaway view illustrating the interior of an automated parking garage upon which an example embodiment is implemented.

FIG. 2 is a block diagram illustrating an example of a level of a parking garage with a designated storage space for containing fires.

FIG. 3 is a block diagram illustrating an example of a of a section of a parking garage that comprises a plurality of levels with a designated storage space for containing fires.

FIG. 4 is a cutaway view illustrating an example of the interior of a designated storage space for containing fires.

FIG. 5 is a block diagram illustrating an example of a system for a parking garage that employs a designated storage space for containing fires 202

FIG. 6 is a method for providing fire protection for a parking garage.

FIG. 7 is a computer system upon which an example embodiment can be implemented.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Disclosed in example embodiments herein are a system, method, and computer readable medium of instructions for providing fire protection in a parking garage. A level or floor of the parking garage has a designated storage space for containing fires (e.g., a hot box or fire box). Sensors in storage spaces (e.g., parking areas) detect whether there is a risk of a fire (e.g., a heat signature or smoke indicating a fire may be starting and/or a fire is active) in a storage space. In an example embodiment where the garage is an automated (e.g., robotic) parking garage that employs pallets, a horizontal carrier module, which can be an upper-level carrier module or an entry exit station carrier module, automatically moves the pallet, which may have a vehicle, a container, or any kind of item stored thereon, to the designated storage space for containing fires. In an example embodiment, an alarm can be provided at a user interface and an input at the user interface causes the horizontal carrier module to move the pallet from the storage space where a fire was detected to the designated storage space for containing fires. In other embodiments, a robotic dolly or other mechanism that is employed to move vehicles within the garage is employed to move the vehicle to the designated storage space for containing fires.

In an example embodiment, vehicle storage spaces are monitored by sensors in garages equipped with a designated storage space for containing fires (also referred to herein as a “FIRE BOX”) protection. A sophisticated fire alarm system is capable of detecting heat (e.g., a heat signature that is indicative of a risk of a fire) before visible flames appear. This early warning system allows for a rapid response before the situation becomes critical. Once a predefined condition is detected, such as an amount of heat (e.g., critical heat) above a predetermined threshold is detected, the robotic system automatically transports the at-risk vehicle, or other content in the storage space, to the FIRE BOX. In an example embodiment, this process takes less than 90 seconds, significantly reducing the window for a fire to develop (Recent reports from the Research Foundation NFPA show that the development of flames occurs about two minutes after heat detection).

In an example embodiment, the FIRE BOX is designed to not only contain but to actually extinguish fires. It features advanced extinguishing methods that are effective against standard and Electric Vehicle (EV) battery fires, ensuring that the fire is controlled and extinguished before it can develop.

In an example embodiment, the FIRE BOX is equipped with a standpipe system outside each platform level, a smoke evacuation system, and an at least two-hour rated envelope observation window. These features allow firefighters to monitor the situation safely and ensure that the fire is fully extinguished.

The National Fire Protection Association (NFPA) develops and publishes standards and codes for fire safety. The Fire Resistance Rating (FRR) is the amount of time a material can withstand fire while maintaining its structural integrity. For example, a two-hour rating means that the materials employed for constructing a door, wall, floor, and/or window can maintain structural integrity for two hours.

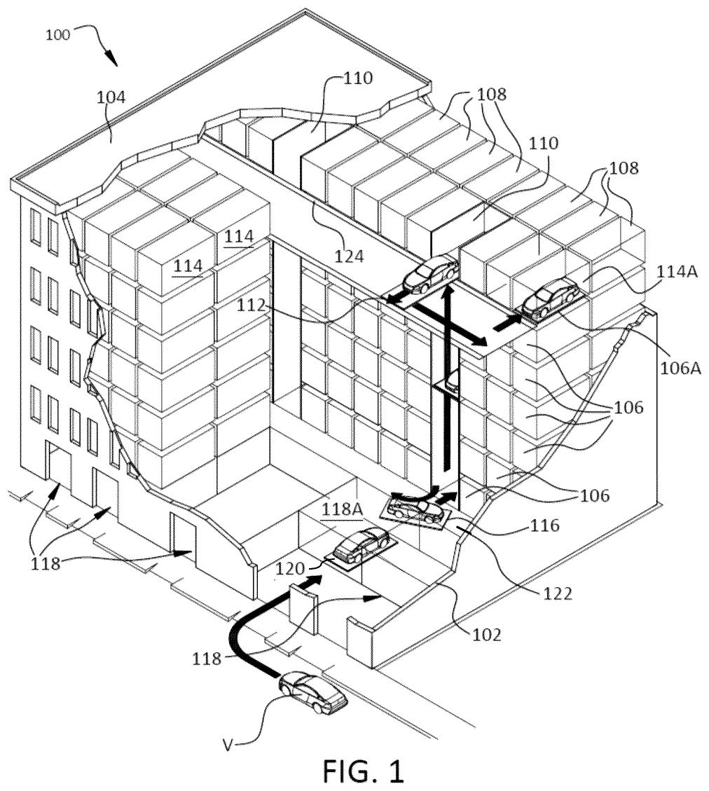

FIG. 1 is a cutaway view illustrating the interior of an automated parking garage 100 upon which an example embodiment is implemented. In the illustrated example, portions of the exterior wall 102 and roof 104 are removed in order to view the interior of the automated parking garage 100.

In the illustrated example, the automated parking garage 100 comprises a plurality of levels (or floors) 106 and a plurality of vertical storage units 108 (which are used for parking vehicles but can also be used to store storage containers, thus storage units 108 may also be referred to herein as “parking spaces” or “storage spaces” on the plurality of levels 106. The automated parking garage 100 further comprises a vertical lift carrier (“VLC”) 110, upper horizontal carriers (“UCM”) 112, and entry level carrier (“ELC”) 116, and a plurality of entry exit stations (also referred to herein as “terminals”) 118. In the illustrated example, the storage (or parking) units 108 have two storage spaces 114 that can be parking space configured to parking cars and/or storing containers. Thus, storage space 114 may also be referred to as a parking space.

The entry level carrier 116 transports a vehicle along the entry level of the automated parking garage 100. For example, the ELC 116 can transport vehicle V from an entry/exit station 118 to a vertical lift carrier 110 and/or to storage units 108 on the entry level. The vertical lift carrier 110 transports the vehicle V between floors and the upper horizontal carrier 112 transports the vehicle V along a floor, such as for example to or from a VLC 110 and a storage unit 108.

In an example embodiment, the parking garage 100 has storage spaces 114 on both sides of the aisle 122 as illustrated in FIG. 1. Those skilled in the art can readily appreciate that in other embodiments there may be vertical storage units 108 located on one side of the aisle 122.

In the illustrated example, the vertical storage unit 108 has two storage spaces 114 per level 106. As those skilled in the art can readily appreciate, other embodiments may have a single storage space 114 or any other physically realizable number of storage spaces.

In operation, when a vehicle V enters an entry exit station 118A, the vehicle V drives onto a pallet 120. In an example embodiment, the pallet is made of steel, however, those skilled in the art can readily appreciate that any suitable material can be employed for pallet 120. In an example embodiment, the pallet is treated with fire retardant and/or fire resistant paint or coating. There are many types of fire retardant, fire resistant, and flame-retardant paints commercially available. Intumescent paints and cementitious coatings are two commonly used fire-resistant coatings. The pallet 120 with vehicle V thereon are transferred to entry level carrier 116 located in aisle 122.

In an example embodiment, a container (not shown) can be stored on the pallet 120. Customers can employ the container for storage and the container can be stored in a storage space 114. See U.S. Patent Publication No. 2023/0220697 A1, the contents of which are hereby incorporated in their entirety, for an example of using containers for storage in a robotic parking garage.

In an example embodiment, the entry level carrier 116 is rotated one hundred and eighty degrees. Thus, when the vehicle V is later retrieved for departure, it is facing the entrance of a terminal 118 obviating the need for the driver to back out of the garage 100. In the illustrated example, the vehicle V is being parked on a different level than the terminal 118A. The vehicle is transferred to a vertical lift carrier 110 for transport to the appropriate level. Once at the appropriate level 106 106A in this example, the vehicle V is transferred to an upper horizontal carrier 112. The upper horizontal carrier 112 is motorized and is operable to travel horizontally via rail 124. The upper horizontal carrier 112 transports the vehicle V adjacent to storage (parking) space 114A, and the vehicle is transferred into storage (parking) space 114A.

As those skilled in the art can readily appreciate, the number of levels 106, vertical storage units 108, vertical lift carriers 110, upper horizontal carriers 112 parking spaces 114, entry level carriers 116, and terminals 118 were merely selected for ease of illustration, and that the principles described herein can be applied to automated parking garages having any desired, physically realizable number of levels 106, vertical storage units 108, vertical lift carriers 110, upper horizontal carriers 112 parking spaces 114, entry level carriers 116, and terminals 118. Thus, the example embodiments described herein should not be construed as being limited to the configuration of the automated parking garage 100 illustrated in FIG. 1.

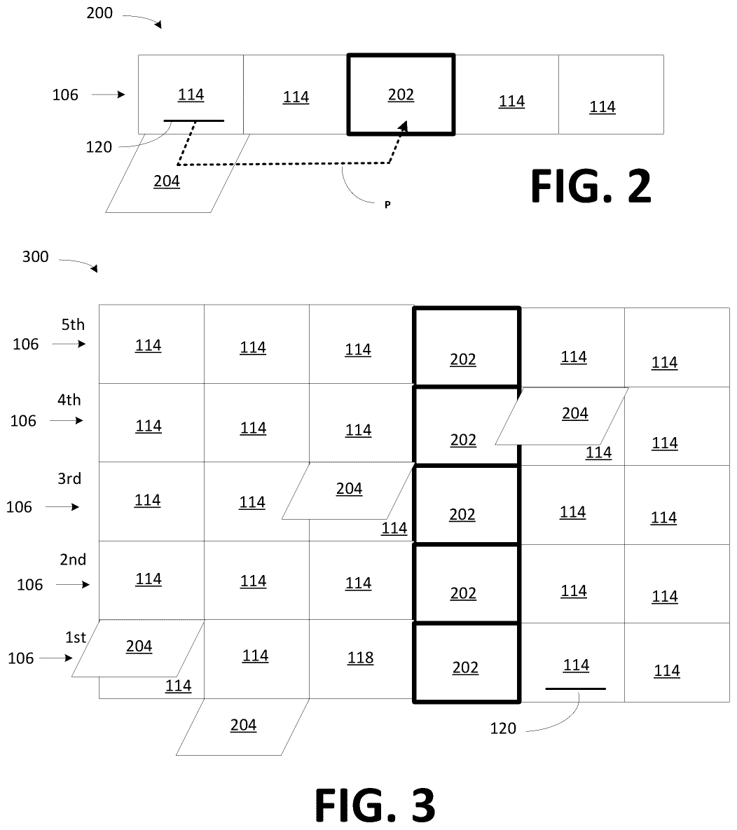

FIG. 2 is a block diagram illustrating an example of a level 106 of a parking garage with a designated storage space for containing fires 202. The level 106 comprises a plurality of storage spaces 114. The plurality of storage spaces 114 can be configured to store a pallet 120 upon which can be mounted a vehicle, a container, or any other item to be stored.

The level 106 further comprises a designated storage space for containing fires 202. The designated storage space for containing fires 202 is comprised of fire resistant or flame resistant materials, for example noncombustible materials, such as concrete, fiberglass, mineral wool, or composites which in particular embodiments are chemically treated. In an example embodiment, the concrete around the designated storage space for containing fires 202 is comprised of fire resistant and/or fire retardant materials. In particular embodiments, the designated storage space for containing fires 202 can be coated by intumescent paint, can have a layer of lightweight mortar on exposed surfaces and/or any other suitable feature that improves the resistance of concrete.

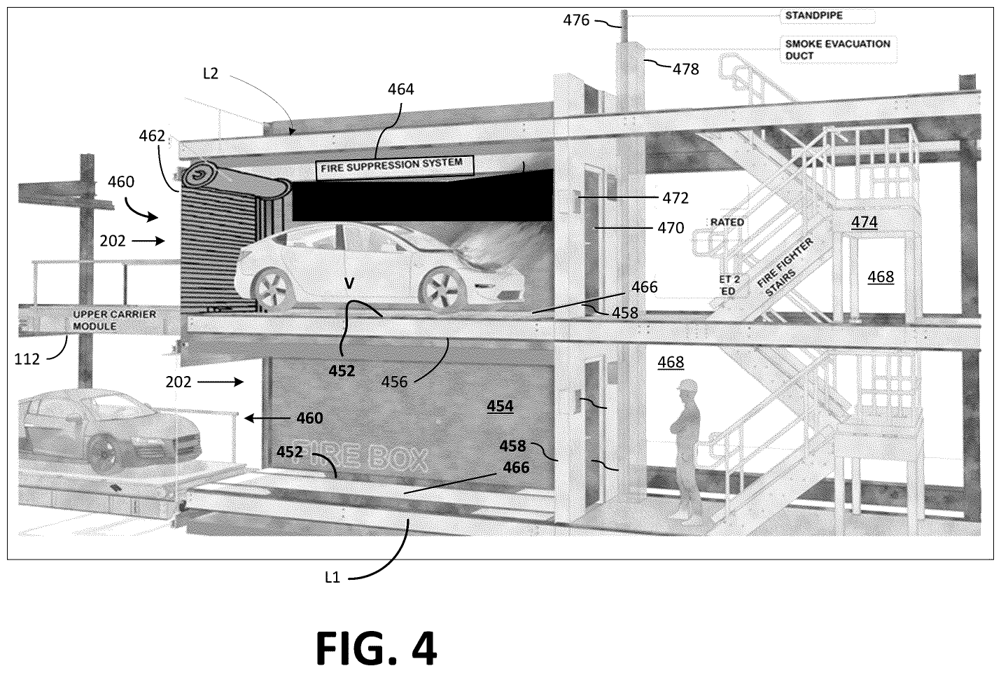

In an example embodiment, the designated storage space for containing fires 202 further comprises a door (not shown, see e.g., FIG. 4) for sealing the designated storage space for containing fires 202. The door can be any suitable type of door (e.g., hinged, roll door, sliding door, etc. that is also composed of fire resistant or flame resistant materials.

In an example embodiment, the designated storage space for containing fires 202 further comprises a fire suppression system (not shown, see e.g., FIG. 4). For example sprinkles, deluge or water-mist or systems which flood the designated storage space for containing fires 202 with inert gas or special foams can be employed.

In an example embodiment, the level 106 further comprises a horizontal carrier 204. The horizontal carrier 204 can be either an upper horizontal carriers (“UCM”) 112, or an entry level carrier (“ELC”) 116. In operation, as will be explained further herein infra, the horizontal carrier 204 retrieves the pallet 120 (and the contents thereon) from a storage space 114 where a fire has been detected and moves the pallet 120 to the designated storage space for containing fires 202 and puts the pallet into the designated storage space for containing fires 202 as illustrated by path P. Once the fire is extinguished, the horizontal carrier 204 can be employed to remove the pallet 120 from the designated storage space for containing fires 202.

Although the description herein describes a garage that employs pallets to transport contents (e.g., vehicles and/or containers), those skilled in the art can readily appreciate that this is merely for ease of illustration and that the principles described herein can be applied to garages that do not employ pallets for transporting contents, for example garages that employ dollies. As with a pallet, a dolly can move the contents (e.g., vehicle) from a storage space where a fire has been detected to the designated storage space for containing fires 202. In particular embodiments, the dolly employed for transporting the contents of a storage space where a fire is detected is reinforced to withstand fires.

As those skilled in the art can readily appreciate, the number storage spaces 114 and designates spaces for containing fires 202 were selected merely for ease of illustration. Systems employing the features described herein can have any physically realizable number of storage spaces 114, entry exit stations 118, and designated storage spaces for containing fires 202. For example, floors having a large number of storage spaces 114 and/or entry exit stations 118 can have multiple designated storage spaces for containing fires 202.

In the illustrated example, the designated storage space for containing fires 202 is located at the center of the level. This can provide shorter average travel times to the designated storage space for containing fires 202. However, this is not a requirement and those skilled in the art can readily appreciate that the designated storage space for containing fires 202 can be located at any desired location on the level.

FIG. 3 is a block diagram illustrating an example of a section 300 of a parking garage 100 that comprises a plurality of levels 106 with a designated storage space for containing fires 202. In the illustrated example, each floor has a designated storage space for containing fires 202 and a horizontal carrier 204. In the illustrated example the horizontal carriers 204 are in random locations. Having an available designated storage space for containing fires 202 on every level shortens the amount of time to move a pallet 120 from a storage space 114 to a designated storage space for containing fires 202 because the pallet does not have to move to a different level. However, if the designated storage space for containing fires 202 is already occupied, or if the fire is on a floor where one is not present, the pallet 120 can be transported to a vertical lift carrier (“VLC”) 110 (not shown, see e.g., FIG. 1) and transported to a level that has an available designated storage space for containing fires 202.

In an example embodiment, a level 106, such as the first floor, may have an entry exit station (“EES”) 118. If a fire is detected in the EES 118, the horizontal carrier 204 can remove the pallet from the EES 118 and place it into the designated storage space for containing fires 202.

In an example embodiment, the designated storage spaces for containing fires 202 are located in the same column. This can save costs because designated storage space for containing fires 202 will require additional support, such as for example, for additional concrete employed to make the designated storage space for containing fires 202 fire resistant.

FIG. 4 is a cutaway view illustrating an example of the interior of a designated storage space for containing fires 202 (which may also be referred to herein as a hot box or fire box). In the illustrated example, there are two designated storage spaces for containing fires 202 that are located on different levels L1, L2.

The designated storage spaces for containing fires 202 comprises a floor 452, sidewalls 454, a ceiling 456, a rear wall 458, and an opening 460 at the entrance of the designated storage space for containing fires 202. A door 462 is operable to open to allow vehicles that are on fire to be stored in the designated storage space for containing fires 202, and close to contain the fire within the designated storage space for containing fires 202. In an example embodiment, the door 462 is an overhead door, however, any suitable type of door can be employed.

In an example embodiment, the floor 452, sidewalls 454, ceiling 456, and rear wall 458 are comprised of materials (for example thermal clay bricks) rated for at least 2 hours. In other embodiments, the floor 452, sidewalls 454, ceiling 456, and rear wall 458 are rated for at least 4 hours (e.g., comprised of nine and one-quarter inch concrete). In an example embodiment, door 462 is a fire door. In particular embodiments, the door 462 is a fire rated door that is rated for at least 90 minutes, and in other embodiments may be rated at either at least 180 minutes.

In particular embodiments, the designated storage spaces for containing fires 202 further comprises a fire suppression system 464. Once a vehicle that is on fire is moved into the designated space for containing fires 202, the fire suppression system 464 is employed to extinguish the fire.

In an example embodiment, a steel pallet 466 is employed to move the vehicle into an out of the designated storage space for containing fires 202. In an example embodiment, the steel pallet 466 is rated for at least 2 hours. In other embodiments, the steel pallet 466 is rated for at least 4 hours.

In an example embodiment, the rear wall 458 comprises an access door 470. Access door 470 provides access to the designated storage space for containing fires 202 from an area 468 that is adjacent to the designated storage space for containing fires 202. For example, access door 470 can allow firefighters access to the designated storage space for containing fires 202. The access door 470 can be a fire door, or a fire rated door that is rated for at least 30, 60, 90, 120, 360, or 480 minutes.

In an example embodiment, the rear wall 458 comprises a window 472. This can allow firefighting personnel the ability to view the fire before entering the designated storage space for containing fires 202. The window 472 can be rated for at least 2 hours or 4 hours. In particular embodiments, the rear wall 458 comprises both an access door 470 and a window 472.

In an example embodiment, area 468 adjacent to the rear wall 458 comprises fire rated stairs 474 that allows personnel to navigate and access the designated storage spaces for containing fires 202 on different levels, e.g., L1,L2. In an example embodiment, the fire rates stairs 474 are rated for at least 2 hours. In other embodiments, the fire rates stairs 474 are rated for at least 4 hours.

In an example embodiment standpipe 476 is coupled with the designated storage space for containing fires 202. The standpipe 476 can be coupled with the fire suppression system 464 and is operable to assist in extinguishing fires in the designated storage space for containing fires 202.

In an example embodiment, a smoke evacuation duct 478 is coupled with the designated storage space for containing fires 202. In particular embodiment, the smoke evacuation duct is equipped with a smoke evacuation fan.

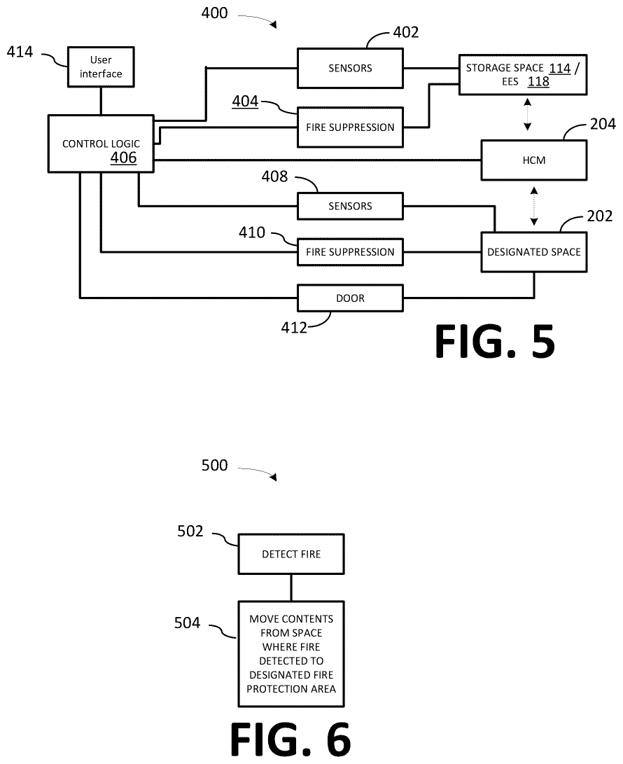

FIG. 5 is a block diagram illustrating an example of a system 400 for a parking garage that employs a designated storage space for containing fires 202. The system 400 comprises storage spaces 114 and/or entry exit stations 118, Horizontal Carrier Modules (HCM) 204, and designated storage spaces for containing fires 202.

In an example embodiment, sensors 402 are deployed at the storage spaces 114 and/or entry exit stations 118. The sensors can be single, or any combination of, any suitable type of sensor for detecting a fire within a storage space 114 or entry exit station 118. Examples of suitable sensors include, but are not limited to, temperature sensors, infrared (IR) sensors (or flame detectors, IR sensors can detect infrared radiation emitted by objects, including hotspots and abnormal temperature increases. Infrared cameras can identify potential fire risks before the situation escalates), ultraviolet (UV) sensors (or flame detectors), multi-spectrum infrared (MSIR) flame detectors, visual flame imaging flame detectors, optical cameras (which may be monitored by garage personnel), smoke detectors, Gas Detectors (Gas Detectors can Detect flammable gases, like hydrogen and methane, and trigger an alarm if any gases are detected above a predefined threshold). Gas detectors with LEL-MPS, O2, CO, and HF sensors can provide early warning capabilities), or any combinations of the aforementioned sensors.

In particular embodiment, fire suppression equipment 410 is present in the designated storage space for containing fires 202. Fire suppression equipment 404 can be employed to extinguish, control, or in some cases, entirely prevent fires from spreading or occurring. Examples of fire suppression systems 404, 410 include, but are not limited to, sprinkler systems, such as wet pipe, dry pipe, pre-action, deluge, electronic, foam water sprinkler, water spray, water mist; gaseous agents, such as chemical agent systems, wet chemical and/or dry chemical; and/or fully automatic suppression systems.

The sensors 402, are coupled with control logic 406. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully implemented in software that is embodied on a tangible, non-transitory computer-readable medium that performs the described functionality when executed by one or more processors.

In an example embodiment, a sensor 408, such as described herein, is employed to monitor the storage space. Upon detecting a condition indicative of a fire (e.g., a heat signature or gas above a predefined threshold), the control logic 406 causes the content (e.g., vehicle or container) to be moved to the designated storage space for containing fires 202. As used herein a condition indicative includes pre-ignition detection, such as a hotspot or abnormal temperature increase and/or the detection of one or more predefined gases above a predefined threshold.

In an example embodiment, a sensors 408 can be employed by control logic 406 in the designated storage space to contain fires 202 to determine whether a fire is still active or has been extinguished. In particular embodiments, the control logic 406 can employ fire suppression system 410 to attempt to extinguish the fire.

In an example embodiment, the control logic is operable to control a door 412 at the designated storage space. The door 412 can be any suitable type of door (e.g., roll door, sliding door, or hinged door) to close and prevent the fire from spreading from the designated storage space for containing fires 202. In an example embodiment, the door is comprised of similar materials as the designated storage space for containing fires 202 as described herein.

In an example embodiment, based on data received from a sensor 402, the control logic 406 can determine whether a condition indicative of a fire is present in a storage space 114 or exit entry station 118. In an example embodiment, the control logic 406 employs machine learning to determine whether a condition indicative of a fire is present. Upon detection of a condition indicative of a fire, the control logic 406 is operable to automatically cause the horizontal carrier module 204 to move the pallet from the storage space 114 or exit entry station 118 to the designated storage space for containing fires 202. In an example embodiment, the control logic 406 is further operable to automatically activate the fire suppression system 404 in the designated storage space for containing fires 202.

In an example embodiment, the control logic 406 automatically causes the door 412 at the designated storage space for containing fires 202 to close after the pallet has been placed into the designated storage space for containing fires 202. The control logic 406 is operable to automatically control the fire suppression systems 404, 410 and employ them to attempt to extinguish the fire.

In a manually (e.g., not automated or robotic) parking garage, the control logic 406 displays sensor data from sensors 402 on a user interface 414. An operator can monitor the sensor data from sensors 402 and employ the user interface 414 to operate the horizontal carrier module 204 to move the pallet from storage space 114 or exit entry station 118 to the designated storage space to contain fires 202, and operate fire suppression systems 404, 410, and/or door 412.

In view of the foregoing structural and functional features described above, a methodology 500 in accordance with an example embodiment will be better appreciated with reference to FIG.6. While, for purposes of simplicity of explanation, the methodology 500 of FIG. 6 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an example embodiment. The methodology 500 described herein is suitably adapted to be implemented in logic, such as hardware, software stored on a computer readable medium when executed by a processor, or a combination thereof.

At 502, a condition indicative of a fire is detected. Sensors, such as are described herein, in a storage area and/or an entry exit station can be employed for detecting a fire. The sensors can be any type of sensor, or combination of sensors, capable of detecting a condition indicative of a fire (a fire or pre-ignition conditions) as described herein at the earliest possible moment.

At 504, in response to a fire being detected, the content in the storage space or entry exit station where the fire was detected is automatically moved to a designated storage space for containing fires occurs. The designated storage space for containing fires comprises fire resistant or retardant materials, examples of such materials are described herein.

In an automated or robotic parking garage, the content is moved from the location where a risk of a fire was detected to a designated storage space for containing fires. In an example embodiment, a pallet with a content or a vehicle stored thereon is moved from the storage space or entry exit station where the fire was detected and can be done automatically. In other embodiments, a parking robot or robotic valet is employed to move a vehicle.

In a manually operated garage, an operator can input commands into a user interface to move the contents, such as a vehicle, storage container, EV charging equipment on the pallet (see e.g. FIGS. 10-17 of U.S. Patent Application Publication No. 2023/0220697 already incorporated by reference herein). In an example embodiment, the storage space or entry exit station where the fire was detected is on the same floor as the designated storage space for containing fires. This can provide for quick transport between the storage space or entry exit station where the fire was detected and the designated storage space for containing fires.

In an example embodiment, fire suppression systems can be employed at the designated storage space for containing fires.

In an example embodiment, the storage space for containing fires is equipped with a door. Upon moving the pallet into the designated storage space for containing fires, the door can be closed which can prevent further spread of the fire and/or starve the fire of oxygen.

In an example embodiment, local fire authorities can be notified. This can be done automatically (e.g., by control logic 406 in FIG. 4).

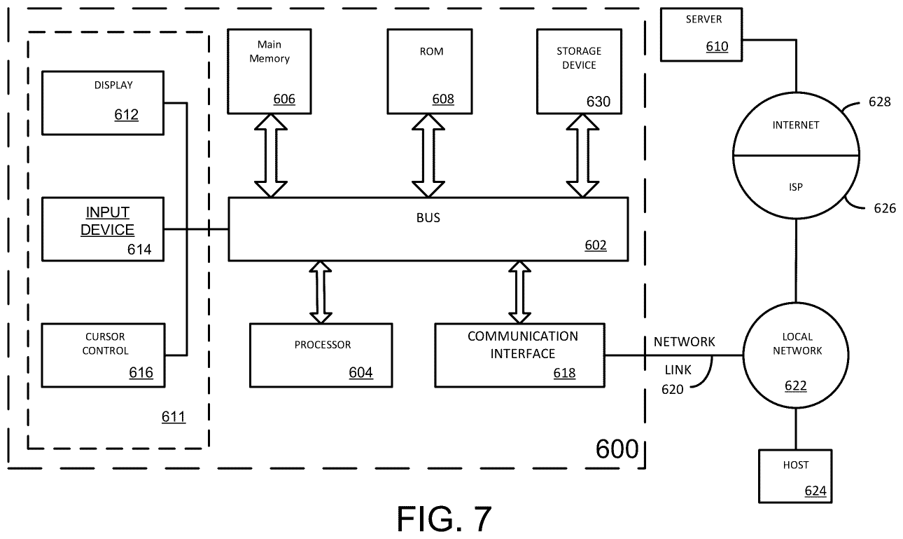

FIG. 7 is a block diagram that illustrates a computer system 600 upon which an example embodiment may be implemented. Computer system 600 can be employed to implement control logic 406 described in FIG. 5 and/or to implement the method 500 described in FIG. 6.

Computer system 600 includes a bus 602 or other communication mechanism for communicating information and a processor 604 coupled with bus 602 for processing information. Computer system 600 also includes a main memory 606, such as random access memory (RAM) or other dynamic storage device coupled to bus 602 for storing information and instructions to be executed by processor 604. Main memory 606 also may be used for storing a temporary variable or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

In an example embodiment, the computer system 600 further comprises a user interface 611. The computer system 600 can be coupled via bus 602 to a display 612 such as a cathode ray tube (CRT), liquid crystal display (LCD), or light emitting diode (LED), for displaying information to a computer user. An input device 614, such as a keyboard including alphanumeric and other keys is coupled to bus 602 for communicating information and command selections to processor 604. Another type of user input device 614 is cursor control 616, such as a mouse, a trackball, or cursor direction keys for communicating direction information and command selections to processor 604 and for controlling cursor movement on display 612. This input device typically has two degrees of freedom in two axes, a first axis (e.g. x) and a second axis (e.g. y) that allows the device to specify positions in a plane. In an example embodiment, the input device 614 is a touch screen.

An aspect of an example embodiment is related to the use of computer system 600 for providing fire protection to a parking garage. According to one embodiment, providing fire protection to a parking garage is provided by computer system 600 in response to processor 604 executing one or more sequences of one or more instructions contained in main memory 606. Such instructions may be read into main memory 606 from another computer-readable medium, such as storage device 610. Execution of the sequence of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 604for execution. Such a medium may take many forms, including but not limited to non-volatile media. Non-volatile media include for example optical or magnetic disks, such as storage device 610. Common forms of computer-readable media include for example RAM, PROM, EPROM, FLASHPROM, CD, DVD, SSD or any other memory chip or cartridge, or other medium from which a computer can read.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communications through the worldwide packet data communication network, now commonly referred to as the “Internet” 628 and can provide communication with a remote server 630. Local networks 622 and Internet 628 both use electrical, electromagnetic, or optical signals that carry the digital data to and from computer system 600, are exemplary forms of carrier waves transporting the information.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a garage with a plurality of storage spaces;
a selected at least one of the plurality of storage spaces is a designated storage space for containing fires;
the selected at least one of the plurality of storage spaces is a designated storage space for containing fires comprises sidewalls, a floor, a ceiling, and a rear wall that comprise materials that can withstand a fire for a predetermined amount of time;
a plurality of sensors for detecting a fire corresponding to the plurality of storage spaces;
a carrier for transporting content to and from the plurality of storage spaces;
a control logic coupled with the plurality of sensors and operable to cause the carrier to transport a content to and from the plurality of storage spaces; and
the control logic, upon determining a condition indicate a fire in one of the plurality of storage spaces, based on data from one of the plurality of sensors, is operable to cause the carrier to transport a content in the one of the plurality of storage spaces to the designated storage space for containing fires.

2. The apparatus set forth in claim 1, wherein the content comprises a vehicle.

3. The apparatus set forth in claim 1, wherein the predetermined amount of time is one of a group consisting of at least two hours and at least at four hours.

4. The apparatus set forth in claim 1, further comprising a door at an entrance to the designated storage space for containing fires that is comprised of a material that can withstand a fire while maintaining structural integrity for a second predetermined amount of time.

5. The apparatus set forth in claim 4, the door is an overhead door.

6. The apparatus set forth in claim 5, the second predetermined amount of time is at least 90 minutes.

7. The apparatus set forth in claim 5, the second predetermined amount of time is at least 180 minutes.

8. The apparatus set forth in claim 1, the carrier module employs a pallet for transporting content to and from the plurality of storage spaces.

9. The apparatus set forth in claim 8, the pallet is rated for at least 2 hours.

10. The apparatus set forth in claim 1, the designated storage space for containing fires further comprising a fire suppression system that is coupled with the 'control logic, the 'control logic is operable to activate the fire suppression system after the content has been placed in the designated storage space for containing fires.

11. The apparatus set forth in claim 10, the designated storage space for containing fires further comprises a standpipe.

12. The apparatus set forth in claim 1, the designated storage space for containing fires further comprises a smoke evacuation duct.

13. The apparatus set forth in claim 1, the rear wall further comprises an access door selected from a group of a fire protection door and a fire rated door that is rated to withstand fires while maintaining structural integrity for at least a second predetermined amount of time.

14. The apparatus set forth in claim 13, wherein the predetermined amount of time is selected from a group consisting of at least 90 minutes and at least 180 minutes.

15. A method, comprising:
determining, by a control logic employing a sensor, a condition indicative of a fire in one of a plurality of storage spaces; and
automatically moving, a content from the one of the plurality of storage spaces where the condition indicative of a fire was detected to a designated storage space for containing fires in response to determining the condition indicative of a fire;
wherein the designated storage space for containing fires comprises a sidewall, a floor, a ceiling, and a rear wall that are comprises of materials that are rated to withstand a fire while maintaining structural integrity for a predetermined amount of time.

16. The method of claim 15, further comprising closing an entrance door to the designated storage space for containing fires after the content has been placed into the designated storage space for containing fires.

17. The method of claim 16, further comprising activating a fire suppression system in the designated storage space for containing fires after the content has been placed into the designated storage space for containing fires.

18. The method of claim 15, further comprising activating a fire suppression system in the designated storage space for containing fires after the content has been placed into the designated storage space for containing fires.

19. The method of claim 15, wherein the predetermined amount of time is selected from a group consisting of at least 2 hours and at least 4 hours.

20. Logic encoded in a tangible, non-transitory computer readable medium for section by a processor and when executed is operable to:
determine, based on data received from a sensor, a condition indicative of an electric vehicle fire for a electric vehicle stored in one of a plurality of storage spaces; and
automatically moving, the electric vehicle from the one of the plurality of storage spaces where the condition indicative of a fire was determined to a designated storage space for containing fires in response to detecting the heat signature;
wherein the designated storage space for containing fires comprises a sidewall, a floor, a ceiling, and a rear wall that are comprises of materials that are rated to withstand a fire while maintaining structural integrity for a predetermined amount of time; and
wherein the predetermined amount of time is selected from a group consisting of at least 2 hours and at least 4 hours.
